(19) United States
(12) Patent Application Publication
(10) Pub. No.: US 2007/0029150 A1
(43) Pub. Date: Feb. 8, 2007

(54) Piston/cylinder unit

(75) Inventors: Jean-Noel Charon, Koblenz (DE); Rolf Mintgen, Thuer (DE)

Correspondence Address: COHEN, PONTANI, LIEBERMAN & PAVANE, 551 FIFTH AVENUE, SUITE 1210, NEW YORK, NY, 10176, US

(73) Assignee: Stabilus GmbH

(21) Appl. No.: 11/496,670

(22) Filed: Jul. 31, 2006

(30) Foreign Application Priority Data
Aug. 1, 2005 (DE) 10 2005 036 595.7

(51) Int. Cl. F16F 9/00

(52) U.S. Cl. 188/322.19; 188/321.11

(57) ABSTRACT

A piston/cylinder unit includes a pressure tube and a piston rod connected to a piston and axially displaceable in the pressure tube. A pressure-tube attachment element for the external connection of the piston/cylinder unit is arranged on the pressure tube and a piston-rod attachment element for the external connection of the piston/cylinder unit is arranged on the piston rod. For adaptation to respective installation conditions, the piston-rod attachment is connected to the piston rod and/or the pressure-tube attachment element is connected to the pressure tube, so as to be adjustable in the axial direction.

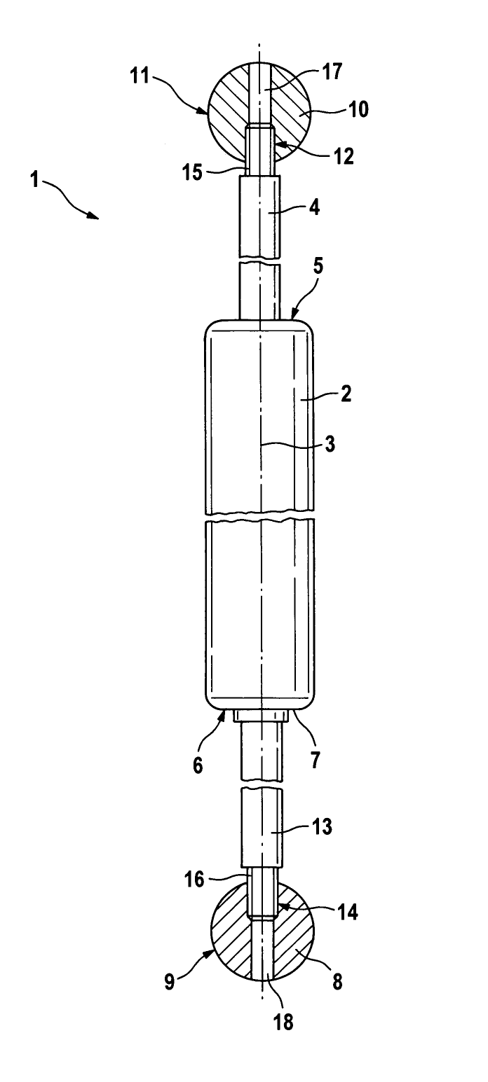

### BACKGROUND OF THE INVENTION

The present invention relates to a piston/cylinder unit, in particular a pneumatic spring, having a pressure tube and an axially displaceable piston arranged in the pressure tube and connected to a piston rod, a pressure-tube attachment element for the external connection of the piston/cylinder unit arranged on the pressure tube, and a piston-rod attachment element for the external connection of the piston/cylinder unit arranged on the piston rod.

An example of a piston/cylinder unit in the form of a pneumatic spring for the movement of flaps or heavy articles is known. Loads can be raised, lowered and secured by the pneumatic spring of the known piston/cylinder unit. The pneumatic spring is a hydropneumatic adjustment element with a cylindrical pressure tube, a piston having a piston rod, and suitable attachments for installation of the pneumatic spring. To install the pneumatic spring, the attachments have attachment elements for the external connection of the pneumatic spring, that is to say for connecting the pneumatic spring to structural parts with which it cooperates. For example, a pressure-tube attachment element of the pneumatic spring may be connected to a body of a passenger car and a piston-rod attachment element of the pneumatic spring may be connected to a tailgate of the passenger car, so that the pneumatic spring assists the opening and, if appropriate, the securing of the tailgate.

Depending on the geometric installation requirements and the kinematic necessities of the respective application, a pneumatic spring specially adapted for this purpose has to be manufactured. This, on the one hand, makes the manufacture of pneumatic springs complicated and, on the other hand, requires costly stock keeping which has to take into account, for example, pneumatic springs of the most diverse possible piston-rod lengths.

### SUMMARY OF THE INVENTION

An object of the present invention is to provide a piston/cylinder unit that is adaptable to different installation conditions in a simple way.

The object of the present invention is achieved by a piston/cylinder unit having a pressure tube and an axially displaceable piston arranged in the pressure tube and connected to a piston rod, a pressure-tube attachment element for the external connection of the piston/cylinder unit arranged on the pressure tube, and a piston-rod attachment element for the external connection of the piston/cylinder unit arranged on the piston rod, wherein the piston-rod attachment element is connected to the piston rod and/or the pressure-tube attachment element is connected to the pressure tube so as to be adjustable in length in the axial direction.

According to this embodiment of the invention, therefore, it becomes possible, by an adjustment in length in the axial direction, that is to say in the direction of the mid-axis of the piston/cylinder unit, to vary the distance between the piston-rod attachment element and the pressure-tube attachment element directly on the piston/cylinder unit and adapt this distance to the respective installation requirements. This obviates the need to manufacture special piston/cylinder units according to the installation requirement, for example by the selection of a piston rod of a specific length or by adapting the pressure tube, and/or to keep such special piston/cylinder units in stock. As a result, the invention leads to a considerable cost reduction not only in terms of manufacture, but also in terms of stock keeping because the stock is kept low. Moreover, piston/cylinder units are available directly even for rarely occurring installation requirements because the manufacture of such piston/cylinder units does not need to be initiated just at the time of an order and consequently the orderer no longer has to wait until delay times have elapsed for manufacture and the manufacturing time itself. A further considerable advantage of the invention is that, even after the installation of the piston/cylinder unit, a renewed adjustment of the piston/cylinder unit can be carried out and therefore, for example, dimensional changes occurring during operation can be compensated. Consequently, the operating reliability and durability of the piston/cylinder units are advantageously increased. In general, by virtue of the invention, tolerance compensation can advantageously be carried out even during the installation of the piston/cylinder unit. The piston/cylinder unit is preferably a pneumatic spring which, in addition to high operating capacity and durability, can also offer, in particular, the advantages of the possibility of a controlled speed of movement, damped end positions, simple mountability, compact dimensions and a flat spring characteristic curve. The piston-rod attachment element and the pressure-tube attachment element are preferably in each case a pivot bolt. However, in principle, the piston-rod attachment element and/or the pressure-tube attachment element could, for example, also have a spherical head for a ball joint.

It would be conceivable that axial length adjustments can be brought about, for example, by means of a wedging and/or clamping device. By contrast, according to an embodiment of the invention, the axial length of the piston/cylinder unit can be set particularly finely, at the same time with a high mechanical stability of the piston/cylinder unit, when the piston rod is connected to the piston-rod attachment element by an axial piston-rod screw connection.

The advantage of exact length adjustability, along with high mechanical stability, also arises when, according to another embodiment of the invention, the pressure tube is connected to the pressure-tube attachment element by an axial pressure-tube screw connection.

According to another embodiment of the invention, the piston rod has an external thread for the piston-rod screw connection, as a result of which, the production of the piston/cylinder unit can be further simplified.

The pressure tube may be incorporated directly with the pressure-tube screw connection. However, the pressure-tube screw connection can be kept small in its dimensions when, according to another advantageous development of the invention, the pressure tube has an axial extension with an external thread for the pressure-tube screw connection.

According to another embodiment of the invention, the external thread of the piston rod is a self-tapping thread, and/or the external thread of the axial extension of the pressure tube is a self-tapping thread. This means that, in a particularly simple way, the external thread of the piston rod can be screwed into a recess of the piston-rod attachment element so as to self-tap an internal thread of the piston-rod attachment element, and/or the external thread of the axial extension of the pressure tube can be screwed into a recess of the pressure-tube attachment element so as to self-tap an internal thread of the pressure-tube attachment element. There is therefore no need to provide the piston-rod attachment element or the pressure-tube attachment element or, if appropriate, connection elements belonging to the attachment elements with a thread for the respective screw connection. Another customary designation for a self-tapping thread is a self-forming thread.

For high stability and rigidity, particularly also when a self-tapping thread is provided, the piston rod and/or the axial extension of the pressure tube made be made from a metal.

According to another embodiment of the invention, the piston-rod attachment element and/or the pressure-tube attachment element is plastic, with the result that favorable sliding and lubricating properties, along with a cost-effective production capability, are achieved. Moreover, when a thread is screwed into a plastic material, there is the advantage of securing as a result of friction.

Other objects and features of the present invention will become apparent from the following detailed description considered in conjunction with the accompanying drawing. It is to be understood, however, that the drawing is designed solely for purposes of illustration and not as a definition of the limits of the invention, for which reference should be made to the appended claims. It should be further understood that the drawing is not necessarily drawn to scale and that, unless otherwise indicated, they are merely intended to conceptually illustrate the structures and procedures described herein.

### BRIEF DESCRIPTION OF THE DRAWING

An exemplary embodiment of the invention is illustrated diagrammatically in the drawing and is explained in more detail below. In the drawing, the single FIGURE is a side view of a piston/cylinder unit according to an embodiment of the present invention.

### DETAILED DESCRIPTION OF THE PREFERRED EMBODIMENTS

The single FIGURE illustrates a piston/cylinder unit 1 designed as a pneumatic spring and having a pressure tube 2. A piston is arranged in the pressure tube 2 which is displaceable in the pressure tube 2 axially in the direction of the mid-axis or longitudinal axis 3 of the piston/cylinder unit 1. In this exemplary embodiment, the piston has a one-sided piston rod 4, which is led out of the pressure tube 2 on one end face 5 of the pressure tube 2.

A completely closed bottom 7 is arranged on end face 6 of the pressure tube, the end face arranged opposite from the end face 5. Although the depicted embodiment includes a one-sides piston rod 4, a two-sided piston rod which is then lead out of both end faces 5, 6 of the pressure tube 2 may alternatively be used.

For its installation, the piston/cylinder unit 1 has, on the one hand, on the pressure tube 2 a pressure-tube attachment element 9, designed here as a pivot bolt 8, for the external connection of the piston/cylinder unit 1 and, on the other hand, on the piston rod 4, a piston-rod attachment element 11, likewise designed here as a pivot bolt 10, for the external connection of the piston/cylinder unit 1. The two pivot bolts 8, 10 consist, in this example, of a plastic.

The piston rod 4 is connected by an axial piston-rod screw connection 12 to the piston-rod attachment element 11 so as to be adjustable in length in the axial direction, that is to say in the direction of the mid-axis 3 of the piston/cylinder unit 1. The pressure tube 2 is connected to the pressure-tube attachment element 9 by an axial pressure-tube screw connection 14, via an axial extension 13 arranged on the bottom 7 of the pressure tube 2, so as to be adjustable in length in the axial direction.

Both the piston rod 4 and the axial extension 13, which in this example both consist of a metal, have a self-tapping external thread 15, 16 at their respective free end region facing away from the pressure tube 2, specifically, on the one hand, for the piston-rod screw connection 12 and, on the other hand, for the pressure-tube screw connection 14.

By means of the self-tapping external thread 15, the piston rod 4 is screwed into a recess 17 of the piston-rod attachment element 11 so as to form the thread of the piston-rod screw connection 12. In the same way, by means of the self-tapping external thread 16 of the axial extension 13, the pressure tube 2 is screwed with the axial extension 13 into a recess 18 of the pressure-tube attachment element 9 so as to form the thread of the pressure-tube screw connection 14.

The piston/cylinder unit 1 described in this exemplary embodiment and having pivot bolts 8, 10 is suitable particularly for installation in a hinge, for example a tailgate hinge of a passenger car. After the piston/cylinder unit 1 has been installed in the hinge, the hinge angle can be set exactly by correspondingly screwing the piston rod 4 into the associated pivot bolt 10 and/or the pressure tube 2 into the associated pivot bolt 8.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A piston/cylinder unit connectable between first and second external components, comprising:
a pressure tube having a longitudinal axis;
a piston rod connected to a piston and axially displaceable in said pressure tube;
a pressure-tube attachment element arranged on said pressure tube for external connection of said piston/cylinder unit to the first external component; and
a piston-rod attachment element arranged on said piston rod for external connection of said piston/cylinder unit to the second external component, wherein at least one of said piston-rod attachment element and said pressure-tube attachment element is adjustable in the direction of said longitudinal axis of said pressure tube.

2. The piston/cylinder unit of claim 1, wherein said piston rod is connected to said piston-rod attachment element by an axial piston-rod screw connection.

3. The piston/cylinder unit of claim 1, wherein said pressure tube is connected to said pressure-tube attachment element by an axial pressure-tube screw connection.

4. The piston/cylinder unit of claim 2, wherein said piston rod has an external thread for the piston-rod screw connection.

5. The piston/cylinder unit of claim 3, wherein said pressure tube has an axial extension with an external thread for the pressure-tube screw connection.

6. The piston/cylinder unit of claim 4, wherein said external thread of the piston rod is a self-tapping thread.

7. The piston/cylinder unit of claim 5, wherein said external thread of said axial extension of said pressure tube is a self-tapping thread.

8. The piston/cylinder unit of claim 4, wherein said piston rod is made of metal.

9. The piston/cylinder unit of claim 5, wherein said axial extension of said pressure tube is made of metal.

10. The piston/cylinder unit of claim 1, wherein said piston-rod attachment element and said pressure-tube attachment element are plastic.

11. The piston/cylinder unit of claim 8, wherein said piston-rod attachment element is plastic.

12. The piston/cylinder unit of claim 9, wherein said pressure-tube attachment element is plastic.

13. The piston/cylinder unit of claim 1, wherein said piston/cylinder unit comprises a pneumatic spring.

14. The piston/cylinder unit of claim 1, wherein each of said piston-rod attachment element and said pressure-tube attachment element is adjustable in the direction of said longitudinal axis of said pressure tube.
